(19) United States
(12) Patent Application Publication
(10) Pub. No.: US 2008/0263930 A1
(43) Pub. Date: Oct. 30, 2008

(54) Lineless Waterfowl Decoy Anchor with Throwing Capability

(76) Inventor: Robert A. Sieman, Amherst, NY (US)

Correspondence Address: PATRICIA M. COSTANZO;PATS PENDING, P.O. BOX 101, ELMA, NY, 14059, US

(21) Appl. No.: 12/168,167

(22) Filed: Jul. 7, 2008

Related U.S. Application Data
(63) Continuation-in-part of application No. 11/155,696, filed on Jun. 17, 2005.

(51) Int. Cl. A01M 31/06

(52) U.S. Cl. 43/3

(57) ABSTRACT

An anchor weight assembly provides for anchoring, throwing, and retrieving a decoy or a set of decoys without any tangling of the members of the set. The assembly is attachable to floating object and includes a rigid rod permanently attached to an environmentally safe, hermetically encapsulated, lead weight. The impermeable encapsulate may be a polyvinylchloride. The rod may be fiberglass or a naturally-occurring material exhibiting rigidity with limited flexure. The floating object may be a decoy, such as a puddle duck decoy with a keel having a receiver aperture for receiving the anchor weight attachment means. One end of the attachment may be a connector means for fastening the attachment means to the floatable object and may also be attached to the rod. Alternatively, if the decoy has a receiver aperture above the keel, the anchor weight attachment means comprises an adapter to provide for such attachment.

### CROSS-REFERENCE TO RELATED APPLICATIONS

This application claims the benefit of application Ser. No. 11/155,696 Jun. 17, 2005.

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND

The present invention relates generally to anchors for floating objects and more particularly to an environmentally safe anchor having no lines or cords to tangle.

The background information discussed below is presented to better illustrate the novelty and usefulness of the present invention. This background information is not admitted prior art.

It is common for hunters when hunting water fowl such as ducks and geese to place decoys on the water to encourage ducks and geese flying overhead to land. The two major classes of ducks hunted are puddle ducks and diving ducks. Puddle ducks, also referred to as dipping, surface-feeding, pond, river, or freshwater ducks are physically and behaviorally different from diving ducks. Physically, puddle ducks differ from diving ducks, in that puddle ducks have unlobed hind feet that are also smaller than the hind feet of diving ducks. This accounts for the fact that puddle ducks rarely dive for their food and, therefore, are most often found feeding in shallow water. Puddle ducks mainly feed on water plants that they obtain by tipping tail-end up in shallow water. In addition to eating water plants, puddle ducks often forage near shore for seeds and insects.

The inventor realized that the use of decoys when hunting the shallow water puddle ducks, such as mallards, black ducks, mottled ducks, Mexican ducks, pintails, gadwalls, American wigeons, shovelers, wood ducks, green-winged teal, blue-winged teal, cinnamon teal, fulvous tree duck, black-bellied tree ducks, and American coots presented a special set of challenges when he was setting his decoys.

A typical puddle duck decoy mimics the shape and color of the shallow water ducks and often is equipped with a weighted keel mounted lengthwise along the decoy's bottom centerline to help maintain the stability of the decoy as it floats on the shallow surface part of a lake, stream, or marsh pond. In order for the decoys to remain in a desired position, the decoys often rely on weights to anchor the decoy on the bottom of the lake, stream, or marsh pond. The weight helps to keep the decoy relatively stationary against the effects of wind or water movement that may be caused by changes in the tide level or by a river current. Whenever the decoy has a keel, a length of line is tied to a tying aperture in the keel and the weight. Presently available decoy anchors are generally made of lead, because of its high specific gravity, although some are made of other metals. Lead, of course, is well known to cause serious pollution, especially when exposed to water. If the weight is made of a different metal, one that is not as polluting as lead, the metal is likely to be adversely affected by the environment. Steel or iron decoy anchors are subject to corrosion during use and storage and become unsightly if not maintained by painting. The paint, however, may also be a pollutant. It would, thus, be desirable to provide a decoy anchor which is attractive in appearance, requires little or no maintenance, is non-polluting, and is easily and compactly storable with the decoy.

The inventor realized that the flexible lines, often made of latex, elastic tubing, that are used along with a length of flexible cord, to attach the decoy to the weight become tangled with each other and with the weeds in the vicinity. The inventor routinely uses several decoys at one time to better simulate natural conditions. Before hunting commences, the inventor has to retrieve his decoy set from storage and transport it to the hunting site. Often, the decoys are stored and transported in a large sack. When the decoys are being transported, the inventor wraps each decoy's line and attached weights around the decoy's neck several times to avoid tangling. But, as there is no way to fasten the lines, the lines and weights often become loose andentangled. While carrying the decoys to the hunting site, the loose weights often knock against his decoys scratching the decoy paint and making a noise that would scare off the birds being hunted.

Once the inventor transports his decoys to the hunting site, he has to place them in the water. A realistic looking, well-placed decoy spread entices more ducks to take come closer to investigate the decoy spread. Proper placement of the decoys results in fewer decoys being needed to attract the hunted ducks, especially when hunting puddle ducks, as puddle ducks, especially early in the hunting season, usually are in smaller groups than diver ducks, and, thus, require fewer decoys to get their attention. The inventor realized that he can attract ducks using fewer decoys, and also become more mobile when he has fewer decoys to place and retrieve every time there is a change in hunting location. Increased mobility means more time to hunt ducks. Throwing decoys to create a properly place decoy spread, however, is not a straightforward effort. Working with decoys attached to weights using flexible cords means that each decoy has to be set by itself to avoid tangling the lines even before the decoys are in the water. And, once in the water it is difficult to place the decoys so that their lines do not become tangled either with each other or with the ubiquitous water plants present in the areas where puddle ducks are found. Moreover, retrieving the decoys means retrieving each decoy separately or else the lines once again would become tangled. The inventor realized that setting and retrieving decoys is a time and energy consuming process. The inventor also recognized that it would be most advantageous to him and to other hunters to have decoys held to anchor weights by means that would eliminate tangling of the decoys with other decoys or with plant life during throwing, floating, retrieval, transport, and storage of the decoys and their anchor attachment assemblies. The inventor knew he would especially appreciate a means for throwing and retrieving a set of decoys all at the same time, thus saving time that could be better used for hunting.

One presently available anchor weight assembly teaches a waterfowl decoy anchor that is typically secured to the decoy by tying a first end of an anchor connecting line of flexible cord to an anchor line receiving aperture in the decoy's keel. Attached to a second end of the connecting line of flexible cord is a first end of an elastic, flexible latex cord, which is attached to an anchor ball of lead or other metal. The anchor ball is sealed up to the tubing with vinyl plastic or rubber, helping to avoid water pollution by lead and corrosion of the ball if made of a metal other than lead. The flexible connecting cord and anchor are wound around the keel for storage. This attempt does nothing to prevent line tangling while the decoy is being thrown in the water, or being retrieved, and only minimally discourages tangling by winding the flexible cord around the decoys when the decoys are being transported or are in storage.

A similar anchor assembly has the anchor line coiled around the decoy and thereafter the strap coiled about the decoy's neck. Then, the anchor is positioned over the bill of the decoy. Decoys with this anchoring system should not become entangled when in storage or being transported to the hunting site. However, the tangling problems that arise when the decoys are thrown in the water, or upon retrieval, are still there.

Another anchor assembly teaches a decoy having an anchor line that is to be wound about the decoy's stabilizing fin (keel) on the bottom of the decoy and retained in place by a hook while being transported. This prevents the tangling of decoy weights and rope while the decoys are being transported to and from the hunting site, but again tangling while the decoys are being set in the water and being retrieved is not prevented.

There is even a bird decoy for attracting predators, for hunting or photographing, that may be supported on a rod or other support means. This decoy is not a floatable decoy and is not designed for use as a puddle duck decoy. The rod to which the decoy is attached is provided for being inserted into the ground, on land or at the bottom of a shallow water body. This rod is not structurally capable of being attached to an anchor.

It is clear then that none of the above anchor assemblies, taken either singly or in combination, provides for a decoy anchor that is attractive in appearance, requires little or no maintenance, is non-polluting, is easily and compactly storable with the decoy and that will not become tangled with other decoys or with plant life during storage, transport, throwing, floating, and retrieval and can be thrown and retrieved as a set of decoys all at the same time, thus saving precious hunting time.

### SUMMARY

The present lineless anchor assembly invention satisfies the current and long unmet, but apparently not recognized, need for an improved lineless, anchor assembly that is attractive in appearance, requires little or no maintenance, is non-polluting and environmentally safe. The anchor assembly of the present invention, comprising a relatively rigid (has a limited amount of flex, but cannot bend), non-elastic, rod with an anchor weight connected to it at one end and at the other end an attachment for attaching the anchor assembly to a floatable object, such as a puddle duck decoy, is easily and compactly storable even when attached to the decoy. Importantly, the lineless anchor does not become tangled with other lineless decoys nor is it likely to become tangled with plant life that grows in the water. Moreover, the lineless anchor according to the principles of the present invention will not become tangled during storage, transport, throwing, floating, and retrieval. Furthermore, the lineless anchor provides means for throwing and retrieving a set of decoys, all at the same time, thus saving hunters from minutes to hours in preparation time, as well as saving similar amounts of time at the end of the hunt when the decoys must be retrieved, transported, and put away in storage. The lineless anchor device of the present invention is ideal for use in flooded fields, swamps, or any open water shallows.

The lineless anchor of the present invention has eliminates tangling decoy lines by eliminating the need for flexible lines. The decoy anchor according to the principles of the present invention utilizes a solid rod that is rigid with a limited amount of flexure, molded directly to a lead weight. The rod is not elastic, as changes in length could make the assembly useless for its intended purpose. Moreover, lead pollution concerns are eliminated by the weight being encased in a watertight, sealed encapsulant.

The decoy anchor as taught herein provides for many advantages in addition to providing an attractive, non-polluting weight for use with puddle duck decoys. When used for anchoring puddle duck decoys, the length of the relatively rigid connecting rod is calculated based on the average water depth that species of waterfowl inhabits. Puddle ducks feed in water that is 18 inches deep or less and will normally land in water of the same average depth therefore, when the anchor weight assembly of the present invention is used to anchor puddle duck decoys, the length should be approximately 14-32 inches. In addition to anchoring the decoys, the anchor provides for a handle to carry the decoys attached to the decoy anchor to and from the hunting site. Because the rigid-like anchor rods cannot become tangled, all of the decoys may be carried to and from the site simultaneously.

Once the site is reached, instead of having to set each decoy individually, several, or all, of the decoys may be thrown at the same time without the worry of line tangling. Prior concerns of having lines wrapping about the decoys and tangling with one another has been eliminated. Once the decoys have been placed in the water the anchor weight, molded onto the rod, settles to the bottom of the water body to hold the decoys in place.

When hunting is finished for the day, the decoys are lifted from the water using the encapsulated anchor weight as a comfortable and functional carrying handle. All of the decoys may be carried at the same time, again without fear of having lines tangled. Multiple trips to and from the water to retrieve each decoy are eliminated. This saves valuable time, as well as eliminating frustration when setting up the decoy spread and when bringing the decoys in at the end of the day.

The present invention also provides for efficient storage and transport of the decoys with or without the lineless anchor weights attached to the decoys. After retrieving all of the decoys, the lineless anchor weights may be left attached to the decoys for easy placement of the decoys, even if the lineless anchors are left attached to the decoys, into the decoy bag and for easy retrieval of the decoys/anchors from the bag. If desired, however, the lineless anchors may be rapidly detached from the decoys simply by opening the heavy duty clasp that is part of each of the attachment means of the lineless anchor device.

Moreover, that lineless anchor device of the present invention provides for its attachment directly to the anchor line receiving hole that is present in the keel of most duck decoys. The decoy anchor device of the present invention also provides for the attachment of the device to those decoys that have their anchor attachment receiver hole above the keel by providing for adapters.

The present invention supplies all of these benefits and more by providing for:

An anchor weight assembly, comprising:
a lineless anchor weight assembly, comprising:

a) a rigid rod of a desired length, the rigid rod having a high modulus of elasticity that provides for a minimal amount of flexure defined as a curve having an arc of greater curvature than an arc of a closed circle, the rigid rod having a first end and a second end;

b) at least one attachment means for attaching anchor weight assembly to the duck decoy, the attachment means having a first end and a second end, wherein said second end of said attachment means is attached to the first end of the rigid rod, and

c) an anchor weight fixedly attached to the second end of the rigid rod, wherein the first end of said attachment means provides for attachment of the anchor weight assembly to a floatable object to maintain the object in a desired position while floating eliminating the use of any connecting lines of a flexibility that can lead to tangling.

In a preferred embodiment the anchor weight is made of lead, and in a more preferred embodiment the anchor weight is made using molten lead providing for the rod to be permanently encased into a first end of the anchor weight,

Following the principles of the present invention, the anchor weight is impermeably sealed prohibiting the anchor weight from interacting with the environment providing for the anchor assembly to be environment compatible.

In the favored embodiment, it is further contemplated that the anchor weight is impermeably sealed using a synthetic organic polymer, wherein the synthetic organic polymer may be a polyvinylchloride.

Another favored embodiment contemplates wherein the rod is made from a synthetic organic polymer, wherein the synthetic organic polymer may be a fiberglass. Alternatively, the rod is made of a naturally-occurring material that can exhibit rigidity.

Yet still, another favored embodiment contemplates wherein the floating object is a duck decoy, that may be a puddle duck decoy that further comprises a keel wherein the keel further comprises a receiver aperture functionally adapted for receiving the anchor weight attachment means.

An additional favored embodiment provides for:

a) one end of the attachment means to further comprise an optional flexible fastener providing for fastening the attachment means to the rod, and

b) a second end of the attachment means to further comprise a connector means for fastening the attachment means to the floatable object that may, optionally attach to the rod.

Furthermore, it is contemplated wherein the lineless anchor weight assembly attachment means is functionally attachable to the puddle duck decoy having a keel with a receiver aperture functionally adapted for receiving the anchor weight attachment means.

Alternatively, it is contemplated wherein the puddle duck decoy comprises a receiver aperture positioned above the keel, where the receiver aperture is functionally adapted for receiving the anchor weight attachment means. Moreover, the receiver aperture, in some decoys, may be positioned above the keel.

It is also contemplated where one of the favored embodiments provides for the anchor weight rod to further comprise:

a) a first end operatively fitted with an end capping means, and

b) a second end is operatively fitted with an end capping means having an optional flange for securing the anchor weight to a bottom of a water body.

The invention also provides for an anchor weight assembly, comprising:

a lineless anchor weight assembly in combination with a duck decoy, comprising:
a) a rigid rod of a desired length, the rigid rod having a high modulus of elasticity that yet provides for a maximum flexure defined as a curve having an arc being of greater curvature than an arc of a closed circle, the rigid rod having a first end and a second end;
b) at least one attachment means for attaching said anchor weight assembly to the duck decoy, the attachment means having a first end and a second end, wherein the second end of the attachment means is attached to the first end of the rigid rod, and
c) an anchor weight fixedly attached to the second end of the rigid rod,
   wherein the first end of said attachment means provides for attachment of the anchor weight assembly to a floatable object to maintain the object in a desired position while floating, providing for the elimination of the use of any connecting lines of a flexibility that can lead to tangling.

The invention also provides for a method for making a lineless anchor weight assembly, comprising the steps of:

a) providing for a rigid rod of a desired length, the rigid rod having a high modulus of elasticity that provides for a maximum flexure defined as a curve having an arc being of greater curvature than an arc of a closed circle, the rod having a first end and a second end;

b) providing for at least one attachment means for attaching the anchor weight assembly to the duck decoy, the attachment means having a first end and a second end;

c) attaching the second end of said attachment means to the first end of the rigid rod;

d) providing for an anchor weight;

e) fixedly attaching the anchor weight to the second end of the rigid rod,

wherein the first end of the attachment means provides for attachment of the lineless anchor weight assembly to a floatable object to maintain the object in a desired position while floating eliminating the use of any connecting lines of a flexibility that can lead to tangling.

Still other benefits and advantages of this invention will become apparent to those skilled in the art upon reading and understanding the following detailed specification and related drawings.

### BRIEF DESCRIPTION OF THE DRAWINGS

In order that these and other objects, features, and advantages of the present invention may be more fully comprehended and appreciated, the invention will now be described, by way of example, with reference to specific embodiments thereof which are illustrated in appended drawings wherein like reference characters indicate like parts throughout the several figures. It should be understood that these drawings only depict preferred embodiments of the present invention and are not therefore to be considered limiting in scope, thus, the invention will be described and explained with additional specificity and detail through the use of the accompanying drawings, in which:

FIG. 1 is a partial perspective view illustrating a decoy set for use in a shallow body of water with the lineless anchor weight assembly of the present invention attached to the decoy.

FIG. 2 is an enlarged elevation sectional view of the decoy with the lineless anchor weight assembly of the present invention, as shown in FIG. 1, for better illustrating the means used to attach the lineless anchor weight assembly to a decoy using a receiver hole that is situated in the keel.

FIG. 2a is an enlarged elevation sectional view of a decoy with the lineless anchor weight assembly of the present invention similar to the decoy as shown in FIG. 1 but different in that the receiver hole is above the keel of the decoy.

FIG. 3a is a perspective view illustrating the anchor weight of this invention with the open end of the encapsulating means ready to receive the molten lead that provides for the weight.

FIG. 3b is a perspective view illustrating the anchor weight of this invention after the molten lead that was poured into the encapsulating means has set with an end cap providing a secure seal over the previously open end of the encapsulation means.

### A LIST OF THE REFERENCE NUMBERS AND PARTS OF INVENTION TO WHICH NUMBERS REFER

2 Puddle duck decoy with receiver hole 6 in keel 4.
2a Puddle duck decoy with receiver hole 6a in keel 4a.
4 Keel of duck decoy 2 with receiver hole 6 in keel.
4a Keel of duck decoy 2 with receiver hole 6 in keel.
6 Receiver hole of keel 4 for receiving anchor weight attachment means 14.
6a Receiver hole above keel 4a for receiving anchor weight attachment means 14.
8 Lineless anchor weight assembly.
10 Puddle duck decoy, set for use in a shallow body of water, with anchor weight and connecting rigid rod of the present invention attached.
12 Connecting rod which is fairly rigid realizing limited flexure (see Definition Section), is non-elastic and is molded to the anchor weight.
14 Attachment means, which are not capable or intended to act as lines, which in the illustrative example are for attaching rod 12 to connector means 16.
16 Connector attachment means 16 attaching attachment means 14 to keel 4 by means of receiver hole 6.
18 Anchor weight.
20 Adapter.
22 Endcap.
24a Aperture.
24b Aperture.
26 Solid lead core of anchor weight 18.
28 Stabilizing means for stabilizing rod until molten lead solidifies.
30 Encapsulation means for encapsulating solid lead core 26 of anchor weight 18.
32a End cap.
32b End cap with optional flange.
40 Open end through which molten lead is poured.

### DEFINITION SECTION

Bend diameter, as used herein, refers to the diameter of the bend in a wire, fiber, or cable. Too severe a bend will cause a crimp, crack, or break in a wire or fiber, in the shielding or insulation surrounding it or the cable in which it resides, or otherwise will compromise the integrity of the physical medium or cabling system. Cable specifications include bend tolerances, generally stated in terms of minimum bend diameter.
Fiberglass, as used herein, refers to material made from extremely fine fibers of glass. Fiberglass is used as a reinforcing agent for many polymer products; the resulting composite material, properly known as fiber-reinforced polymer (FRP) or glass-reinforced plastic (GRP), is called “fiberglass” in popular usage.
Fiberglass solid rod, as used herein, refers to solid, round rods made of fiberglass or reinforced fiberglass that are used in a wide range of applications, providing a unique combination of corrosion resistance, high strength, dimensional stability, having a high modulus of elasticity, and are light weight, along with low thermal and electric conductivity and low maintenance service in areas where steel, aluminum or wood components were traditionally specified. Maximum working temperature is about 150° F. Often used in highly corrosive applications where stainless steel and other expensive components were once required. UV resistant. Solid rod does not provide low flame/spread ratings. Corrosion resistance—providing long life in aggressive acidic or caustic environments. Lightweight and high strength—allowing for more dependable support-to-weight ratio than steel. Dimensional stability—maintaining the cross-section of structural shapes based on a low coefficient of thermal expansion.

Physical Properties of a fiberglass solid rod:

Tensile strength 414-827 MPA (60-120K)

Tensile Modulus 20.6-41.4 MPa (3000-6000 k psi)

Flexural Strength 414-827 MPA (60-120K)

Flexural Modulus 20.6-41.4 MPa (3000-6000 k psi)

Minimum Bend Diameter 80× Diameter
Fishing pole rod, as used herein, refers to the solid rod at the butt end of the fishing pole, such as those made of high-strength carbon fibers impregnated with a thermosetting resin, such as epoxy resin, phenol resin, and polyester resin, and are formed by thermosetting treatment in accordance with conventional methods. As the butt end rod is formed either by the solid rod and an outer layer or by the solid rod alone, a tough and high-strength fishing rod which is capable of coping with large deflection and preventing breakage when a large fish is caught is obtained. As the elasticity of the aforementioned carbon fibers, 30 t/mm² is respectively used, but 40 t/mm²-65 t/mm² may be used for the solid rod 3, 20 t/mm²-50 t/mm² may be used for the outer layer 4, and 20 t/mm²-65 t/mm² may be used for the tip rod 2. If 40 t/mm²-65 t/mm² is used for the solid rod 3, 20 t/mm²-50 t/mm² is used for the outer layer 4, and the elasticity of the outer layer 4 is made lower than that of the solid rod 3, it is possible to obtain a tensile, lightweight, and high-strength fishing rod.
Flexible, as used herein, refers to a material that can be bent and flexed and that is pliable, i.e., easily bent or shaped i.e., material that can be tied into a knot.
Flexure, as used herein, refers to the ability of a material to be forced into a curved shape, such as the flexure of a straight rod. A limited amount of flexure, as used herein, means that the material may be forced into a limited, gentle curve so that its cross-section defines an arc wider than an arc of a closed circle, but the material cannot be bent to form a sharp angle (defined as the space between two lines diverging from a common point).
Keel, as used herein, refers to any weight attached to the bottom of a floating device to prevent the device from being tipped over, as from being tipped over by the wind.
Latex tubing, as used herein, refers to latex tubing that is flexible from subzero to steam sterilization temperatures. It is elastic, as well as flexible, as is witnessed by its “Elongation at Break” value, in fact latex tubing is known for its memory after repeated stretching. It will maintain memory after repeated stretching or pulsating applications. Known for its extreme flexibility, such latex tubing is used extensively in the health care industry, and in other applications such as drain tubing, exercise devices, elastic bands, slingshots, and tourniquet bands, etc.

PHYSICAL PROPERTIES of latex tubing:

Modulus at 300% 190 PSI Max.

Tensile 3,500 PSI Min.

Shore A Durometer Hardness 35±5

Elongation at Break 750% Min.

Specific Gravity 0.95
Line, as used herein, refers to a connecting cable, rope, string, or wire that exhibits either elasticity or flexibility or both.
Lineless, as used herein, refers to an assembly that does not require and does not use a line in order to perform its function.
Minimum bend radius, as used herein, refers to the radius below which an object such as a cable should not be bent. The minimum bend radius is of particular importance in the handling of fiber-optic cables, which are often used in telecommunications. The minimum bending radius will vary with different cable designs. The manufacturer should specify the minimum radius to which the cable may safely be bent during installation, and for the long term. The former is somewhat shorter than the latter. The minimum bend radius is in general also a function of tensile stresses, e.g., during installation, while being bent around a sheave while the fiber or cable is under tension. If no minimum bend radius is specified, one is usually safe in assuming a minimum long-term low-stress radius not less than 15 times the cable diameter.
High modulus of elasticity as used herein, refers to degrees of stiffness of a material that is sought when deflections are undesirable, whereas a low modulus of elasticity is required when flexibility is needed.
Receiver aperture, as used herein, refers to any opening, hole, or aperture designed for the attachment of something, which in this case is a flexible attachment means such as a cord, a wire, or the like.
Rigid, as used herein, refers to a material that has a limited, minimal amount of flexure and a corresponding high modulus of elasticity, so it cannot be considered a flexible (easily bent) or elastic material, i.e., could not be tied into a knot.
Rigid rod, as used herein, refers to a round, solid rod of any relatively rigid material, where relatively rigid means that the rod has a high modulus of elasticity, i.e., a limited amount of flexure, such as a fishing pole rod or a plastic broom handle, but does not posses the flexibility required to bend to the extent that the rod could be tied into a knot or tangled. The length of the rod of the present invention is operatively sufficient to allow for the rod to extend from its point of attachment to a floatable object to its point of attachment to the anchor weight that is part of the anchor assembly and that is sitting on the bottom of the water body upon which the floatable object is floating. The length as required in the invention is from about 14-34 inches.
Sharp angle as used herein, refers to the space between two lines diverging from a common point.

It should be understood that the drawings are not necessarily to scale. In certain instances, details which are not necessary for an understanding of the present invention or which render other details difficult to perceive may have been omitted.

### DETAILED DESCRIPTION

Referring now, with more particularity, to the drawings, it should be noted that the disclosed invention is disposed to embodiments in various sizes, shapes, and forms. Therefore, the embodiments described herein are provided with the understanding that the present disclosure is intended as illustrative and is not intended to limit the invention to the embodiments described herein.

The present invention is directed towards a lineless, anchor weight assembly and to a method for making the assembly. The lineless anchor weight assembly comprises at least one attachment means and a rigid connecting rod from which an anchor weight extends. The at least one attachment means attaches the rigid rod from which an anchor weight extends to a floatable object, such as duck decoy. The rigid connecting rod is permanently attached to an environmentally safe, hermetically encapsulated, solid lead weight. The impermeable encapsulate may be made of a synthetic organic polymer, such as a polyvinylchloride. The rigid connecting rod has a limited amount of flexure, but cannot bend and cannot be classified as flexible (refer to physical property data in Definitions Section) and thus could not be tied into a knot or become tangled with other near by rigid connecting rods of other decoys. In the one favored embodiment that is illustrated herein, the rigid connecting rod is made from fiberglass that offers strength and rigidity with a limited amount of flexure. In embodiment illustrated, the floatable object is a decoy, such as a puddle duck decoy. Decoys traditionally have a keel having a receiver aperture for receiving an anchor weight attachment or connector means. One end of the attachment means, as taught herein, may be a snap means, such as a coast lock snap for fastening the attachment or connector means to the floatable object. The attachment or connector means may be attached directly to the rod, or there may be an additional attachment means between the attachment or connector means and the rod, if desired. Alternatively, if the decoy has its receiver aperture positioned above the keel, the anchor weight attachment means further comprises an optional attachment adapter to provide for attaching the anchor weight and rod to the aperture positioned above the keel. In addition to eliminating tangling of flexible lines that until now were used to connect the floatable object to the anchor weight, the assembly of the present invention provides for anchoring, throwing, and retrieving an entire set of decoys at the same time. When the invention is made exclusively for use in Puddle Duck hunting, the length of the rigid connecting rod is calculated based on the average water depth that relevant species of waterfowl inhabit. Puddle ducks feed in water that is 18 inches deep or less and will normally land in water of the same average depth, therefore the length of the rigid rod is contemplated to be between about 14 and 34 inches. The anchor weight, used in the Puddle Duck hunting embodiment, weighs about 9-ounces. This weight provides enough anchoring power to hold any puddle-duck type decoy in place in water as deep as 32 inches. While wind may move the ducks about, the pattern of the sets placed in open, shallow areas holds as the wind shifts. Moreover, setting patterns becomes much easier to manage with the clip-on anchors of the present invention. The number of decoys a hunter can set depends on how many rigid connecting rods the hunter can wrap his or her hand around. With just a little practice, duck decoys can be thrown two, three, or four at a time, without the need to unwind lines and keep them separated. Yet another advantage of the present advantage is that the time required to takedown a set of decoys at the end of hunt is greatly reduced to just a few minutes. To take down a set of decoys the hunter just lifts one rigid connecting rod connected to a decoy and goes on to the next pickup. Instead of having to wind a flexible connecting line onto each individual duck as is required when using the traditional system. Again, the carrying capacity of retrieved decoys depends on a hunter's fist size, not bag width or throwing abilities. The inventor first tested his decoy anchor in the Niagara River shallows. It works ideally, as intended, when used for puddle duck hunting in shallow waters. The time required to set a dozen decoys in front of a blind using the present invention can be cut to less than half the time required if flexible connecting lines were to be used, and the time required to untangle the flexible lines before or after the hunt is virtually eliminated. Stored end to end, a dozen anchors easily fit in a 6-inch bag ready for a quick draw and setup for the next hunt. The attachment means in the illustrated embodiment is a Coast Lock style clasp with a 150 pound test strength. The clasp is attached to the rod with a short length of waterproof, 200 pound test, braided attachment line. There is a protective rubberized cap at the tip of the rod which helps prevent snagging and prevents damage to the rod tip.

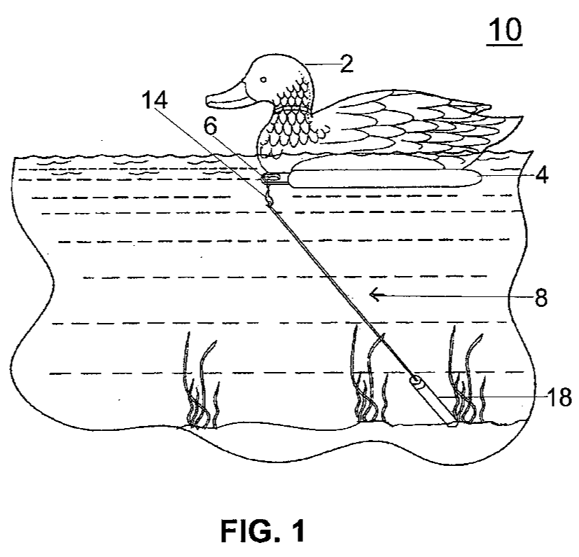

Turning now to the drawings, FIG. 1, a partial perspective view, illustrates lineless anchor weight assembly 8 attached to a floating object according to the principles of the present invention. Puddle duck decoy 2 is used herein for illustration purposes, although it is to be understood that the lineless anchor weight assembly may be used with any other type of floating device, such as a buoy or a marker for instance. In particular, FIG. 1 shows duck decoy 2 set for use in a shallow body of water. Decoy 2 is shown attached to lineless anchor weight assembly 8. Lineless anchor weight assembly 8 comprises rigid connecting rod 12 permanently attached to anchor weight 18 and attachment means 14 for attaching the assembly to the decoy. Attachment means 14 attaches lineless anchor weight assembly 8 to decoy 2 using receiver hole 6 positioned in keel 4 of decoy 2. Rigid connecting rod 12 has the functional amount of rigidity required to ensure that there will be no tangling of the connecting rods of a set of assemblies where each assembly is attached to a decoy. Thus, rigid connecting rod 12 eliminates the tangling problems presented by the flexible lines used by others by eliminating the use of any flexible line.

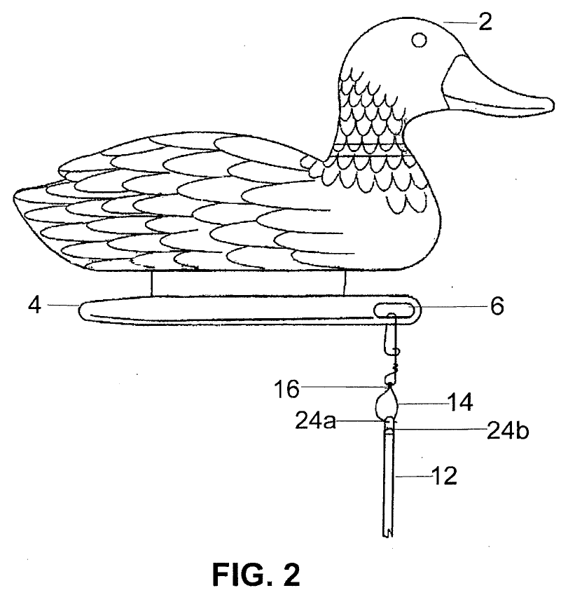

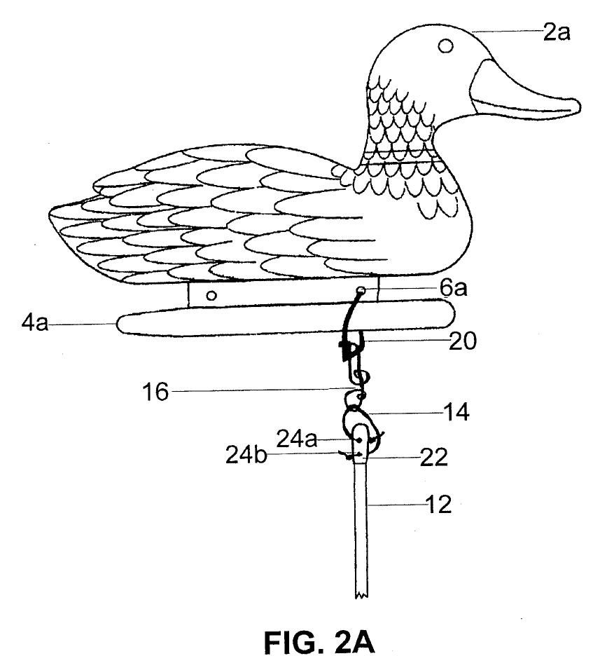

FIG. 2, an enlarged sectional elevation view, illustrates the decoy and the attachment means that attaches the lineless anchor weight assembly of the present invention to the decoy. The embodiment shown in FIG. 2 is one example of an attachment means that may be used to attach the lineless anchor weight assembly to a floating object, such as to decoy 2. In the example shown, a first end of connector means 16 is attached to decoy 2 using receiver aperture 6, which is functionally situated in keel 4. As illustrated, connector means 16 is a coast lock snap with a 150 pound test strength. Connector means 16 is attached to rod 12 using waterproof, 200 pound test, braided connector 14. It is to be understood that instead of being a coast lock snap, connector means 16 may be a swivel snap or any other functional connector. A second end of the braided connector attachment means 14 is attached to a first end of rod 12 through aperture 24a. If desired, only one of the attachment means illustrated may be used. For example, connector means 16 may be configured to be attached directly to the aperture in rod 12. When used with a typical duck decoy, it is recommended for connector means 16 to have strength capable of handling the torque that is created when the decoy with the lineless anchor weight assembly attached is deployed by throwing. Those with ordinary skill in the art are familiar with the multitude of attachment means that may be used to attach the lineless anchor assembly to a floating object and thus, these need not be discussed any further here. Those of ordinary skill in the art will also appreciate that the connectors 14 and 16 are connectors, that is, they are attachment means or devices and are definitely not lines, in that the sense that they are not flexible lines or cords, nor are they the rigid rod of the present invention, where the flexible lines, cords, or rigid rod connects an anchor weight to a floatable object over a distance, such as 14 inches, that is required by presently available anchor weights. The rigid connecting rod of the present invention eliminates the use of the flexible connecting lines or cords required by presently available anchor weights.

FIG. 2a, an enlarged sectional planar view similar, but different to the view presented in FIG. 1 in that the receiver hole used to receive the attachment means of the lineless anchor weight assembly, is positioned above the keel of the decoy. In this example, a first end of connector means 16 is attached to adapter attachment means 20 which in turn is attached to receiver aperture 6a which is functionally situated in keel 4a of decoy 2a. Now, in the same manner as is illustrated in FIG. 2, a second end of connector means 16 is attached to a first end of attachment means 14. A second end of attachment means 14 is attached to a first end of rod 12 through apertures 24a and 24b. As mentioned above, when used with a typical duck decoy, it is recommended that connector means 16 has the strength required to handle the torque created when a decoy with the lineless anchor weight assembly attached is deployed by throwing.

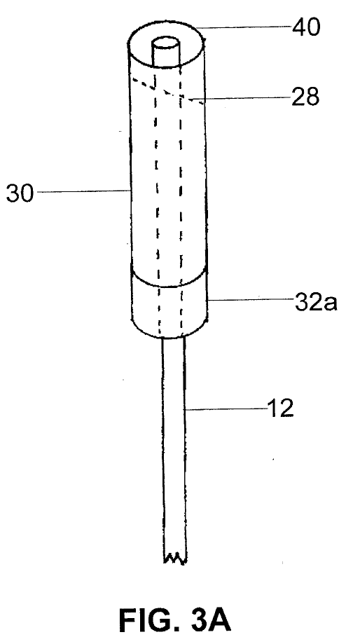

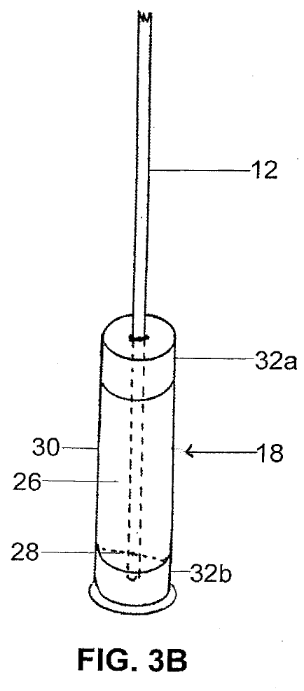

FIG. 3A, a perspective view, illustrates the tubular encapsulating anchor weight container 30 ready for molten lead to be poured into its, still, open end 40. In this example, encapsulating weight container 30 is formed from polyvinylchloride to which the molten lead will bond as it hardens inside container 30. The end of container 30 opposite its open end is a closed end which is shown capped by end cap 32a. Rod 12 is shown positioned in the center of encapsulating means 30 and protrudes through end cap 32a, which can be seen in FIG. 3B. The opening in end cap 32a through which rod 12 protrudes is thoroughly sealed to prevent the environment from coming into any contact with the lead inside of encapsulating means 30. To avoid the displacement of rod 12 away from it centered position during the pouring of the molten lead, rod 12 is collared by metal support collar 28.

FIG. 3B, another perspective view of the anchor weight of this invention, illustrates anchor weight 18 after the molten lead was poured into the encapsulating means and set with end cap 32b providing a secure seal over the previously open end of the encapsulation means. Capping means 32b is sealed over the open end to complete the encapsulation of the lead providing for a heavy lead weight to be safely used in salt or fresh water. In the example provided in FIG. 3b, capping means 32b is shown having a flanged end. The flange, as it gets caught on the mud at the bottom of the water body, provides extra stability for the weight. The flange is optional and may be provided in any number of constructions, such as having finger like struts that will add gripping power to the weight. At this point the desired attachment means for attaching the lineless weight assembly to a floating object are attached to a first end of rod 12 and the assembly is ready for use.

In a preferred embodiment, rod 12 is made from a synthetic organic polymer, such as fiberglass. Alternatively, the rod is made of a naturally-occurring material that can exhibit the rigidity required to eliminate any problems from tangling while maintaining a minimal degree of flexure. In the example shown, rod 12 is contemplated to be solid for added strength. Additionally, rod 12 is contemplated to be lightweight for ease of handling and carrying. The rod may be of any desired length, with the depth of the body of water where the hunting will occurs being a deciding factor for the length of the rod.

To use the lineless anchor weight assembly it is first attached to a floatable object, such as a puddle duck decoy, using the attachment means provided with the lineless anchor weight assembly. Even if a set of objects, such as a set of puddle duck decoys are to be used, the entire set may be lifted at the same time by grabbing either the rigid connecting rods or the handles (i.e., the weights) of the entire set. The set may then be placed into a decoy bag for transport to a hunting site. At the site, the set of decoys with the attached weights may be removed from the decoy bag ensemble as a set by grabbing either the rigid connecting rods or the handles of the entire set. The decoys may then be thrown into position by grabbing the weight that functions also as a handle for throwing the decoy. The decoys may be thrown individually or in groups, as there are no lines to tangle. Once the decoys hit the water, the weight that is molded into the assembly drops to the water's bottom and holds the decoys in place, When the hunt has ended, the decoys may be easily retrieved and placed into the decoy bag for transport and storage with their anchor assemblies still attached without the problems of tangling that are inherent in presently available anchor weight assemblies that rely on connecting lines that are so flexible that the lines may be tied into knots deliberately or accidentally, which usually results in a tangling problem. Alternatively, if desired, the anchor assemblies may be easily and rapidly removed from the decoys by opening the heavy duty clasp of the assembly.

Thus it has been shown that the present invention has eliminated all of the problems of tangling and pollution presented by presently available decoys that all offer elastic and/or flexible lines to attach a metal weight to a decoy. The foregoing description, for purposes of explanation, uses specific and defined nomenclature to provide a thorough understanding of the invention. However, it will be apparent to one skilled in the art that the specific details are not required in order to practice the invention. Thus, the foregoing description of the specific embodiment is presented for purposes of illustration and description and is not intended to be exhaustive or to limit the invention to the precise form disclosed. Those skilled in the art will recognize that many changes may be made to the features, embodiments, and methods of making the embodiments of the invention described herein without departing from the spirit and scope of the invention. Furthermore, the present invention is not limited to the described methods, embodiments, features or combinations of features but include all the variation, methods, modifications, and combinations of features within the scope of the appended claims. The invention is limited only by the claims.

What is claimed is:

1. An anchor weight assembly, comprising:
a lineless anchor weight assembly, comprising:
a) a rigid rod of a desired length, said rigid rod having a high modulus of elasticity that provides for a flexure limited to an arc being of greater curvature than an arc of a closed circle, said rigid rod having a first end and a second end;
b) at least one attachment means for attaching said anchor weight assembly to the duck decoy, said attachment means having a first end and a second end, wherein said second end of said attachment means is attached to said first end of said rigid rod, and
c) an anchor weight fixedly attached to said second end of said rigid rod,
wherein said first end of said attachment means provides for attachment of said anchor weight assembly to a floatable object to maintain the object in a desired position while floating eliminating the use of any connecting lines of a flexibility that can lead to tangling.

2. The anchor weight assembly, as recited in claim 1, further comprising wherein said rigid rod is permanently encased into a first end of said anchor weight wherein said anchor weight is made of lead.

3. The anchor weight assembly, as recited in claim 1, further comprising wherein said rigid rod is between about 14 and 34 inches long.

4. The anchor weight assembly, as recited in claim 1, further comprising wherein said lead anchor weight is impermeably sealed prohibiting said anchor weight from interacting with the environment.

5. The anchor weight assembly, as recited in claim 4, further comprising wherein said anchor weight is impermeably sealed using a synthetic organic polymer.

6. The anchor weight assembly, as recited in claim 5, further comprising wherein said synthetic organic polymer is a polyvinylchloride.

7. The anchor weight assembly, as recited in claim 1, further comprising wherein said rigid rod is made from a synthetic organic polymer.

8. The anchor weight assembly, as recited in claim 7, further comprising wherein said synthetic organic polymer is a fiberglass.

9. The anchor weight assembly, as recited in claim 1, further comprising wherein said rigid rod is made from a naturally-occurring material that can exhibit rigidity.

10. The anchor weight assembly, as recited in claim 1, further comprising wherein said floating object is a decoy.

11. The anchor weight assembly, as recited in claim 10, wherein said decoy further comprises being a puddle duck decoy.

12. The anchor weight assembly, as recited in claim 11, wherein said puddle duck decoy further comprises a keel.

13. The anchor weight assembly, as recited in claim 12, wherein said keel further comprises a receiver aperture functionally adapted for receiving said anchor weight attachment means.

14. The anchor weight assembly, as recited in claim 13, wherein said attachment means further comprises a Coast Lock style clasp.

15. The anchor weight assembly, as recited in claim 1, wherein:
a) said one end of said attachment means further comprises an optional flexible fastener providing for fastening said attachment means to said rigid rod, and
b) said second end of said attachment means further comprises a connector means for fastening said attachment means to said floatable object.

16. The anchor weight assembly, as recited in claim 12, wherein said puddle duck decoy further comprises a receiver aperture positioned above said keel, said receiver aperture functionally adapted for receiving said anchor weight attachment means.

17. The anchor weight assembly, as recited in claim 16, wherein said anchor weight attachment means further comprises an adapter providing for said anchor weight to attach to said puddle duck decoy having a receiver aperture positioned above said keel, said receiver aperture functionally adapted for receiving said anchor weight attachment means.

18. The anchor weight assembly, as recited in claim 1, further comprising wherein said anchor weight rigid rod further comprises:
a) said first end operatively fitted with an end capping means, and
b) a second end is operatively fitted with an end capping means having an optional flange for securing said anchor weight to a bottom of a water body.

19. An anchor weight assembly, comprising:
a lineless anchor weight assembly in combination with a duck decoy, comprising:
a) a rigid rod of a desired length, said rigid rod having a high modulus of elasticity that provides for a flexure limited to an arc being of greater curvature than an arc of a closed circle, said rigid rod having a first end and a second end;
b) at least one attachment means for attaching said anchor weight assembly to the duck decoy, said attachment means having a first end and a second end, wherein said second end of said attachment means is attached to said first end of said rigid rod, and
c) an anchor weight fixedly attached to said second end of said rigid rod,
wherein said first end of said attachment means provides for attachment of said anchor weight assembly to a floatable object to maintain the object in a desired position while floating eliminating the use of any connecting lines of a flexibility that can lead to tangling.

20. A method for making a lineless anchor weight assembly, comprising the steps of:
a) providing for a rigid rod of a desired length, said rigid rod having a high modulus of elasticity that provides for a flexure limited to an arc being of greater curvature than an arc of a closed circle, said rod having a first end and a second end;
b) providing for at least one attachment means for attaching said anchor weight assembly to the duck decoy, said attachment means having a first end and a second end;
c) attaching said second end of said attachment means to said first end of said rigid rod;
d) providing for an anchor weight;
e) fixedly attaching said anchor weight to said second end of said rigid rod, wherein said first end of said attachment means provides for attachment of said lineless anchor weight assembly to a floatable object to maintain the object in a desired position while floating eliminating the use of any connecting lines of a flexibility that can lead to tangling.
